(19) United States
(12) Patent Application Publication
(10) Pub. No.: US 2007/0276739 A1
(43) Pub. Date: Nov. 29, 2007

(54) Intermediary for Multiple Sales Channels

(75) Inventors: Ashvin J. Mathew, Kirkland, WA (US); Nicolae Surpatanu, Redmond, WA (US); Douglas DeFonzo, Newton, MA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/419,939

(22) Filed: May 23, 2006

(51) Int. Cl. G06Q 30/00

(52) U.S. Cl. 705/26

(57) ABSTRACT

This document describes tools that enable merchants to sell items through multiple sales channels without requiring the merchants to interact directly with those sales channels. These tools also permit merchants to learn and interact with as little as one user interface. A merchant may, for example, sell items through the merchant's own physical, brick-and-mortar store, an auction website, a fixed-price website, and the merchant's own website using a single user interface. Embodiments of these tools also enable customers to tracks purchases made through multiple sales channels with a single user interface. If a customer buys one of a merchant's items from an independent website and another from the merchant's own website, for example, the tools may permit the customer to view both of these purchases through a single user interface.

### BACKGROUND

Currently, merchants often have to interact with multiple user interfaces when selling through multiple sales channels. Assume, for instance, that a hobby store wants to sell a model train on an auction website, a book about building trains on a fixed-price website, and a miniature train station at the hobby store's own website. To do so, the hobby store contacts the auction website, enters all the information about the model train into the auction website's own user interface, and then, once the model train sells, contacts the auction website's user interface again, and records into the hobby store's accounting or inventory system (often by hand) that it sold and to whom, when, the shipping address, and payment method. For the book offered for sale on the fixed-price website, the hobby store may enter all the information about the book through the fixed-price website's user interface; wait for the sale; go back to the fixed-price website's user interface to see if it sold; record information about the sale by hand; and so forth. And for the miniature train station, the hobby store will need to interact with its own website. Dealing with three different sales channels through three different user interfaces can be time consuming and inefficient.

Similarly, customers may have to interact with multiple user interfaces when purchasing items through multiple sales channels. Assume that a customer is interested in model trains—he purchases the model train through the auction website, the book through the fixed-price website, and the miniature train station through the hobby store's own website. If the customer wants to keep track of all of his orders he may need to interact with all three sales channels: the auction website; the hobby store's website; and the fixed-price website, even though he purchased all three items from the hobby store. Not only is this inefficient, this lack of integration may also preclude certain savings, such as having all three shipped together to save on shipping or purchased together to reduce credit-card transaction fees.

### SUMMARY

This document describes various embodiments of tools that enable merchants to sell items through multiple sales channels without requiring the merchants to interact directly with those sales channels. These tools also permit merchants to learn and interact with as little as one user interface. In one embodiment, a merchant may, for example, sell items through the merchant's own physical, brick-and-mortar store, an auction website, a fixed-price website, and the merchant's own website using a single user interface.

Embodiments of these tools also enable customers to tracks purchases made through multiple sales channels with a single user interface. If a customer buys one of a merchant's items from an independent website and another from the merchant's own website, for instance, the tools may permit the customer to view both of these purchases through a single user interface.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “tools,” for instance, may refer to system(s), method(s), computer-readable instructions, and/or technique(s) as permitted by the context above and throughout the document.

### BRIEF DESCRIPTION OF THE DRAWINGS

FIG. 1 illustrates an exemplary operating environment in which various embodiments of the tools may operate.

FIG. 2 is an exemplary flow diagram showing actions and/or communications between an intermediary application and examples of other elements of FIG. 1.

FIG. 3 illustrates an exemplary user interface into which a merchant has entered seven items and selected to sell six of those items through four sales channels.

FIG. 4 is an exemplary flow diagram showing actions and/or communications between elements of FIG. 1 that may follow after those of FIG. 2.

FIG. 5 is an exemplary flow diagram showing actions and/or communications between elements of FIG. 1 that may follow after those of FIG. 4.

FIGS. 6 and 7 show an exemplary process illustrating various embodiments and manners in which the tools may act as an intermediary for multiple sales channels.

The same numbers are used throughout the disclosure and figures to reference like components and features.

### DETAILED DESCRIPTION

### Overview

The following document generally describes various embodiments of tools capable of enabling merchants to sell items and customers to track purchases made through multiple sales channels. An environment in which the tools may enable these and other actions is set forth below in a section entitled Exemplary Operating Environment. This is followed by another section describing one exemplary embodiment showing how the tools enable a hobby store to sell items and customers to track purchases made through multiple sales channels. This section is entitled: Example for One Merchant. Another section follows and describes these and other embodiments and manners in which the tools may act as an intermediary between one or more merchants, customers, and sales channels and is entitled Other Embodiments of the Tools. This overview, including these section titles and summaries, is provided for the reader's convenience and is not intended to limit the scope of the claims or the entitled sections.

### Exemplary Operating Environment

Before describing the tools in detail, the following discussion of an exemplary operating environment is provided to assist the reader in understanding some ways in which various inventive aspects of the tools may be employed. The environment described below constitutes an example and is not intended to limit application of the tools to any particular operating environment. Other environments may be used without departing from the spirit and scope of the claimed subject matter.

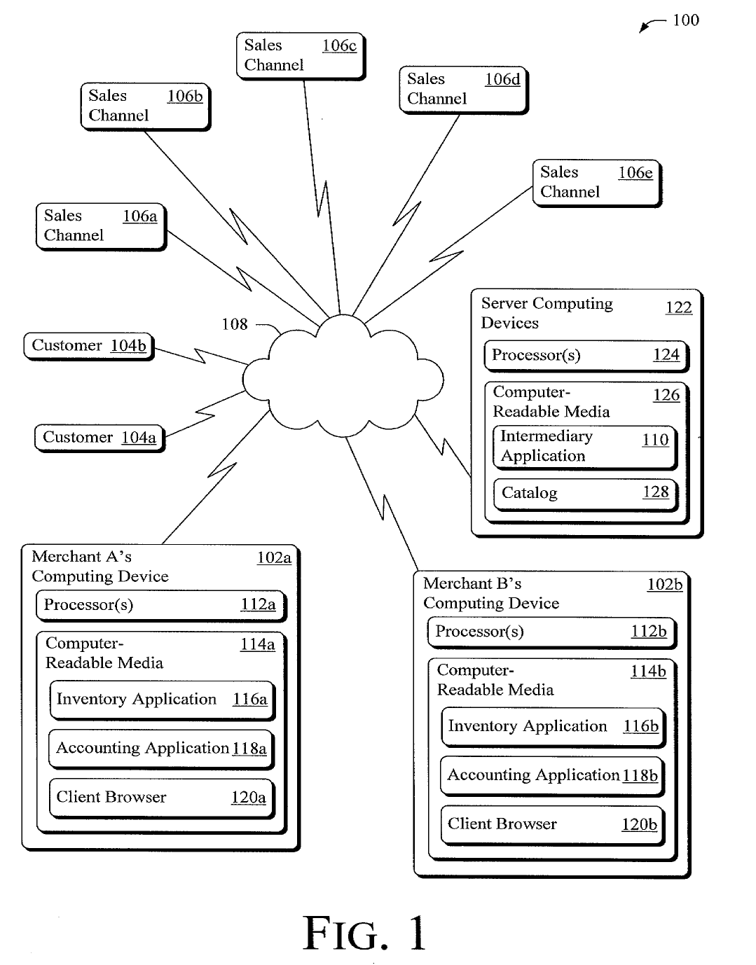

FIG. 1 illustrates one such operating environment generally at 100 having two merchants with computing devices 102a and 102b, two customers 104a and 104b, five sales channels 106a, 106b, 106c, 106d, and 106e, a communications network 108, and an intermediary application 110. The network enables communication between these entities and may comprise a local and/or global network, such as a company intranet or the Internet.

The term “merchant” may refer to a person or a computing device through which the person may act as will be apparent by the context. Merchants 102a and 102b include a computing device having one or more processor(s) 112a or 112b and computer-readable media 114a or 114b. The processor(s) are capable of accessing and/or executing the computer-readable media. The computer-readable media may comprise one or more of: an inventory application 116a or 116b; an accounting application 118a or 118b; and a client browser 120a or 120b capable of interacting with the intermediary application.

Intermediary application 110 may act local to any of the entities of environment 100, though here it is shown on one or more server computing devices 122 having processor(s) 124, computer-readable media 126, and a catalog 128 in addition to the intermediary application. The processor(s) are capable of accessing and/or executing the computer-readable media. The computer-readable media may comprise or have access to the intermediary application and the catalog.

Five types of sales channels are shown and may comprise, by way of example, mixed auction and fixed-price sales websites (e.g., Ebay™ for auction sales and “buy-it-now” sales), fixed-price websites (e.g., Amazon.com™), a merchant's own website, which may offer fixed-price sales and general item information whether for sale on the website or not, a physical point of sale (e.g., a merchant's physical “brick-and-mortar” shop), search engines having sales or links to sales channels, and price-comparison websites offering fixed-price sales (e.g., pricescan.com™). Note that a physical point of sale may be connected to the merchant's own inventory or accounting applications directly rather through the network, though connection through a network is also possible (e.g., by a sales application that record sales and permit access to them via a network). Although a physical point of sale typically would be in the merchant's store such as at the checkout counter, it is not necessarily located in the merchant's store. For example, when a customer purchases a product via a mobile device such as a mobile phone, the physical point of sale may be the location of the mobile user. In the former case, the point of sale hardware and software might include a cash register, bar code scanner, and the back-end software (e.g., inventory, accounting, etc.) necessary to make the system work. In the latter case, the point of sale hardware and software might include the mobile device, the wireless network (e.g., cellular, WLAN such as IEEE 802.11, Bluetooth, etc.) over which the mobile device communicates,

### Example for One Merchant

In this example a hobby store interacts with a single user interface of the intermediary application to sell items through four different sales channels. The hobby store only needs to understand and interact with this one interface rather than four. Once the hobby store selects where it wants to sell its items, the intermediary application interacts with the sales channels and customers effective to enable the sales channels to sell the items and the customers to stay informed about their purchases.

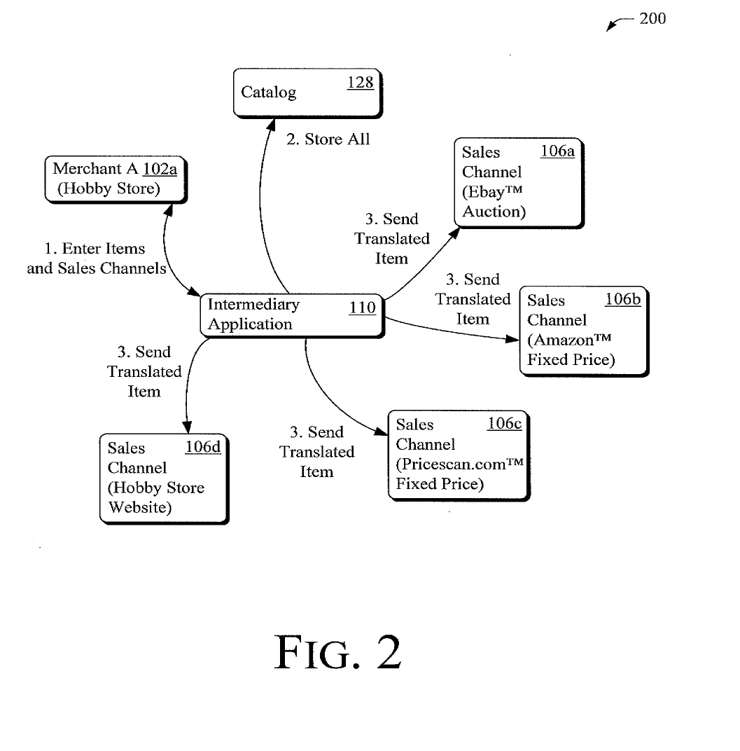

FIGS. 2, 4, and 5 illustrate this example with flow diagrams showing actions and/or communications by and between exemplary elements of FIG. 1, such as the hobby store, the intermediary application, the sales channels, and two customers. In these flow diagrams communications are made over network 108 though the network is not shown.

At arrow 1 in FIG. 2, Merchant A (102a of FIG. 1), which here is a hobby store, enters into a single user interface provided by the intermediary application items and sales channels through which to offer those items for sale. The hobby store may enter the items manually or upload them from his or her inventory application 116a of FIG. 1 using a public API. If uploaded, the intermediary application translates the items from the data format used by the hobby store's inventory application to that used by the intermediary application.

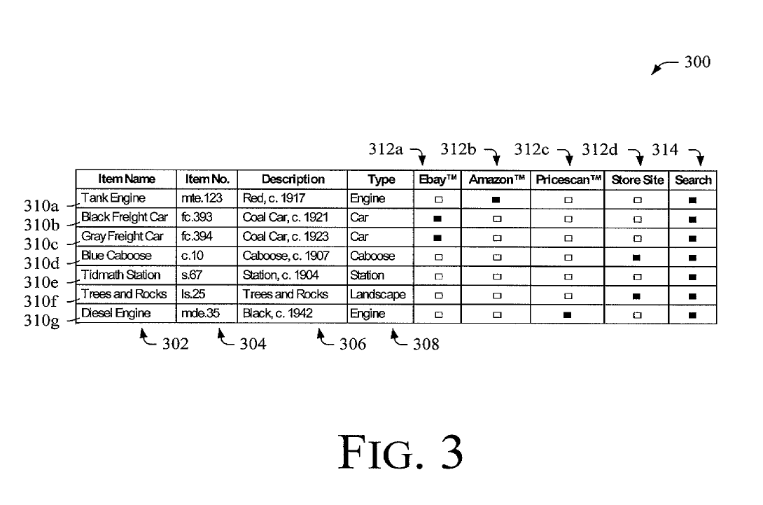

In the embodiment shown, the interface has generic and specific information. The generic information is properties that are common to most items and most sales channels. Some examples of these properties are shown in an example inventory interface 300 of FIG. 3 and include each item's name 302, item number 304, description 306, and type 308 (pictures may also be included but are not shown). Seven items 310a, 310b, 310c, 310d, 310e, 310f, and 310g are currently listed with their generic properties.

The hobby store then selects sales channels through which to offer the items for sale. Here examples of the four sales channels 106a through 106d of FIG. 1 are listed, along with selectable boxes 312a through 312d by which to select to sell an item through that channel. Note that the hobby store did not select one of the items for sale (310e) by any of the sales channels; the intermediary may retain this and the other item's properties to act as a unified inventory system for the hobby store. The hobby store may also select to expose properties for any of the items to search engines (whether the engines are also sales channels or not), including the item not selected for sale, through selecting the box 314 in that item's row.

Also at arrow 1 and responsive to the hobby store's selections, the intermediary asks for specific information where appropriate. For the auction items, for instance, the intermediary provides a pop-up window (not shown) asking for an auction start time, minimum price, auction end time, and allowable payment methods (e.g., paypal™). The intermediary may auto-populate these fields based on a retained history of the hobby store's habits. Here the intermediary knows that for auctions-based websites the hobby store chooses a start time for the next Thursday at noon and ending the next Monday at 6 p.m. Thus, the intermediary may populate this information for any of the items selected for an auction site (here items 310b and 310c for Ebay™ auctions).

For items to be offered for sale to fixed-price sales channels (here items 310a, 310d, 310f, and 310g to Amazon™, the hobby store's own site twice, and pricescan.com™, respectively), the intermediary may ask for a price and acceptable payment methods. Here the intermediary also knows that the hobby store always exposes its items to search engines, and so fills in those boxes as shown in FIG. 3.

At arrow 2 the intermediary application stores the items, their generic and specific information, and selected channels and/or engines in catalog 128. As noted above this catalog may be used by the intermediary to provide a single inventory for the hobby store, thereby permitting the hobby store to forgo using its own inventory application 116a. Of course, the catalog 128 is not necessarily stored at server 122 in all embodiments. In certain embodiments, the catalog 128 may be stored on a remote data server, such as a data warehouse, accessible by server 122 via the network 108. In some embodiments, the catalog 128 may even be stored on the merchant's computer and accessed by the server 122 over the network 108 via a web-based interface.

Also at arrow 1 or 2 the intermediary determines which items are selected to be offered for sale and through which sales channels. This may be responsive to the hobby store's explicit selection or inferred automatically from the current context and historical transactions. For example, the intermediary may automatically determine that a caboose will be sold through the merchant's website because the merchant has only sold cabooses through his own website in the past and has not sold them through other channels such as Ebay™, etc.

At arrow 3 the intermediary translates the generic and specific information into a data format acceptable by the sales channel or engine to which it will be offered for sale or search and sends those facts to those channels and engines. The intermediary keeps a record of the data format of each channel and engine sufficient to transform facts desired by the channel or engine into a form acceptable to each of them. Thus, for item 310a (the tank engine) intended for auction on Ebay™, the intermediary provides the item's name, number, description, type, auction start time, auction end time, minimum price, and acceptable payment method to Ebay™ in a form acceptable to Ebay™. Here the data format is identical to the one used by Ebay's™ own interface for selling items by auction. The intermediary sends each item's facts using an RSS (Really Simple Syndication) feed.

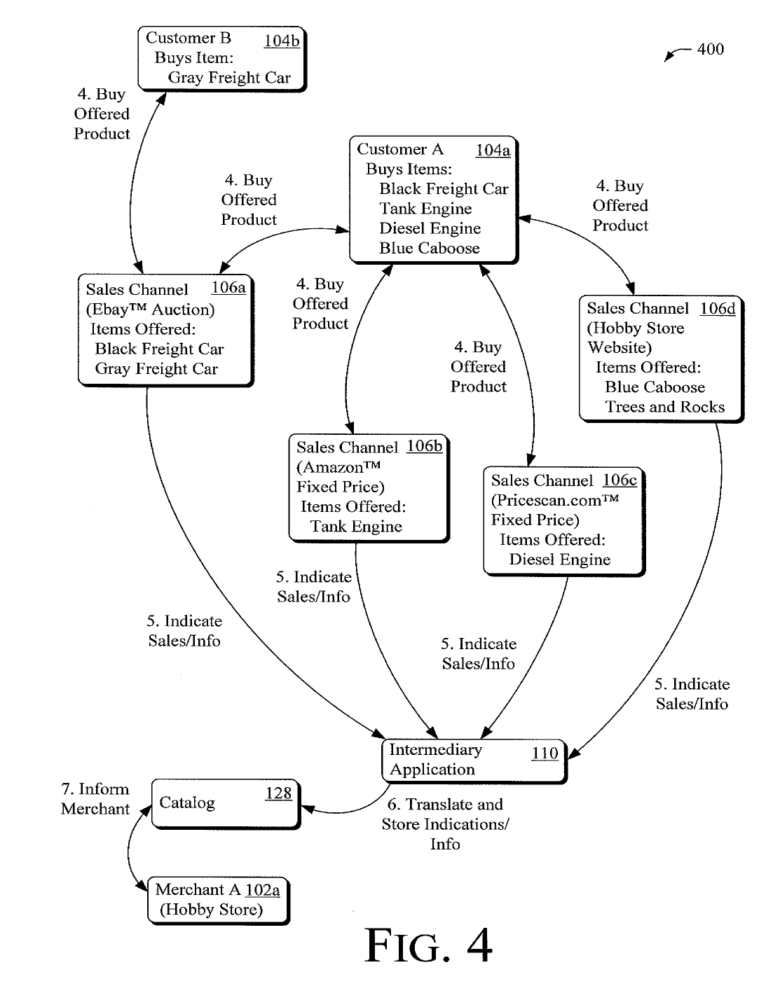

At arrow 4, which is shown in FIG. 4, the sales channels offer the hobby store's items for sale and some of them are purchased by Customers A and B (examples of 104a and 104b of FIG. 1). Here Customer A purchases the black freight car through Ebay™, the tank engine through Amazon™, the diesel engine through pricescan.com™, and the blue caboose through the hobby store's own website. Customer B purchases the gray freight car through Ebay™. The trees and rocks offered through the hobby store's own website do not sell.

Also at arrow 4 the customers provide customer-related information, such as their names, addresses, account numbers, payment methods, and the like. Customer A, for example, may provide the following to Ebay™ on purchasing the black freight car:
Jim Smith
123 Main Street,
Anytown, Washington
99018
Paypal™ account number: 039402343
Shipping method selected: UPS Ground

And Customer A may also provide the following to Amazon™ on purchasing the tank engine:
Jim Smith
123 Main Street,
Anytown, Washington
99018
Visa Credit Card number: 71093874102397
Shipping method selected: FedEx Ground

Customer A may provide more information incident to purchasing the diesel engine from pricescan.com™ and the blue caboose from the hobby store's website, such as his interest in being on a model train mailing list. The sales channels record Customer A's customer-related information. They may also store sales-related information, such as which items sold, when, at what price, to whom, and fees charged by the sales channel.

At arrow 5 each of the sales channels indicate their sales to the intermediary in a data format acceptable to or used by the sales channel along with sales and customer information. Here the indications are in the same data format as that used by each sales channel's own sales interface intended for merchants. Thus, the sales channels may not need any customization to interact with or knowledge of the intermediary's actions or existence.

At arrow 6 and after receipt of the indications from the sales channels, the intermediary translates information sent along with the indication from the data format used by each sales channel into the data format used by the intermediary. At arrow 6 the intermediary also stores the translated indications and information in the catalog.

At arrow 7 the intermediary informs the hobby store of the sales, such as with by a simple indication that the sales have been made or with all data related to the sale. Here the intermediary informs the hobby store that a sale was made and to check the interface in which the hobby store entered the items for more information. This interface now presents data about the sales by exposing portions of the catalog. The interface is the same interface into which the hobby store entered the items at arrow 1 but now includes information about the sales.

For the sale of the black freight car, for instance, the following is presented to the hobby store:
Item Name Black Freight Car
Item No.: fc.394
Item Description Coal Car., c. 1921
Type: Car
Offered by Ebay™ and exposed to Search Engines
Sold through Ebay™ by Auction at 6 p.m. on Monday
Customer information:
Jim Smith
   123 Main Street,
   Anytown, Washington
   99018
   Paypal™ account number: 039402343
   Shipping method selected: UPS Ground
Purchase price: $17.94
Shipping cost: $5.34
Ebay™ fees for sale: $0.93

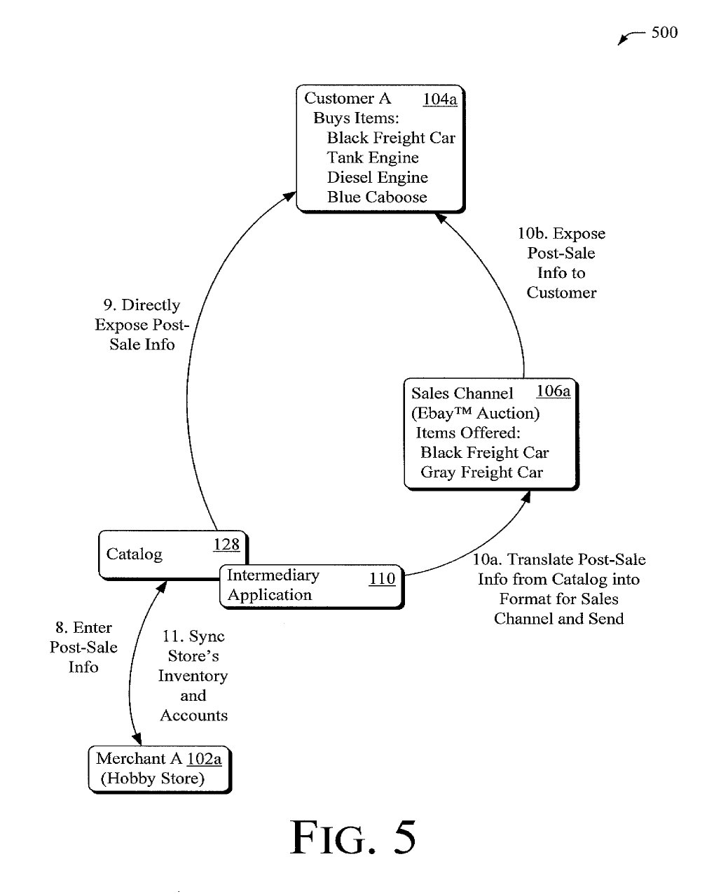

By showing the hobby store all of his entered items, sales, and information related to those sales, the intermediary may provide a complete view of the hobby store's inventory and its status. The hobby store knows which items are not sold (the trees and rocks and Tidmath Station), which are sold (the rest of the items) and when and to whom. The intermediary also permits the hobby store to enter post-sale information to further integrate the hobby store's inventory and sales. The intermediary enables the hobby store to enter post-sale information, such as shipping information like a shipment date, carrier, and tracking number once each item has been shipped. The intermediary may also store this shipping information in the catalog (shown at arrow 8 in FIG. 5). In some embodiments, the intermediary enables the merchant to reduce shipping costs by flagging all of the purchases made by, for example, Jim Smith, so that all of Jim's purchases can be shipped together.

The intermediary exposes this post-sale information directly to the customers at arrow 9 or indirectly at arrows 10a and 10b. For arrow 9 the intermediary exposes those items in the catalog to the customers that purchased them (except for sensitive information), such as the item name, number, description, purchase price, and shipping information. Thus the intermediary provides a record for purchasers to view, here for purchases from the hobby store though other merchants' sales may also be exposed to that purchaser as well.

Note that the intermediary, by exposing all of the customer's purchases (either for all merchants or just the hobby store) enables the customer to track purchases through one interface, instead of the interfaces for Ebay™, Amazon™, the hobby store's site, and pricescan.com™, as may otherwise be the case for Customer A.

At arrows 10a and 10b the intermediary (in part through the sales channels) may make the information available to Customer A. At arrow 10a the intermediary translates the shipping information from the catalog into a data format acceptable to Ebay™ and each of the other sales channels. Also at arrow 10a it sends the translated information to the sales channels using an RSS feed. The sales channels may then expose this information at arrow 10b, such as by sending a tracking number for a shipped item by email to the customer. FIG. 5 only shows sales channel 106a (e.g., Ebay™) for simplicity.

At arrow 11 the intermediary provides accounting and/or inventory information to update the hobby store's accounting application 118a or inventory application 116a. Here the intermediary provides the following to the accounting application for the purchase of the black freight car:
Item No.: fc.394
Received from: Paypal™ account number: 039402343
Purchase price: $17.94
Shipping cost: $5.34
Sales fees for sale: $0.93
Net before actual shipping costs: $22.35

With this information the accounting application may update the hobby store's accounts without requiring the hobby store to manually enter this information. Also with information from the catalog the intermediary may download enough information in a data format acceptable to the inventory application such that the hobby store will not need to manually enter any information about the sales.

### Other Embodiments of the Tools

This section describes the above and other embodiments and manners in which the tools may act as an intermediary between merchants, customers, and sales channels effective to permit merchants to sell items and customers to track purchases made through these sales channels. In some embodiments whatever information can currently be exchanged between merchants and interfaces specific to sales channels may instead be exchanged through a single user interface provided by intermediary application 110. In this way the intermediary may permit merchants to sell items through sales channels without requiring that the merchants use multiple interfaces or conform to multiple data formats, which often breeds confusion and may require manual copying from one interface to another. Similarly, the intermediary may permit customers to track items bought through different sales channels and merchants with a single user interface. In some embodiments, the intermediary application may use a self-documenting schema, such as Extensible Markup Language (XML), for data exchange with the sales channels, merchants, customers, or catalogs.

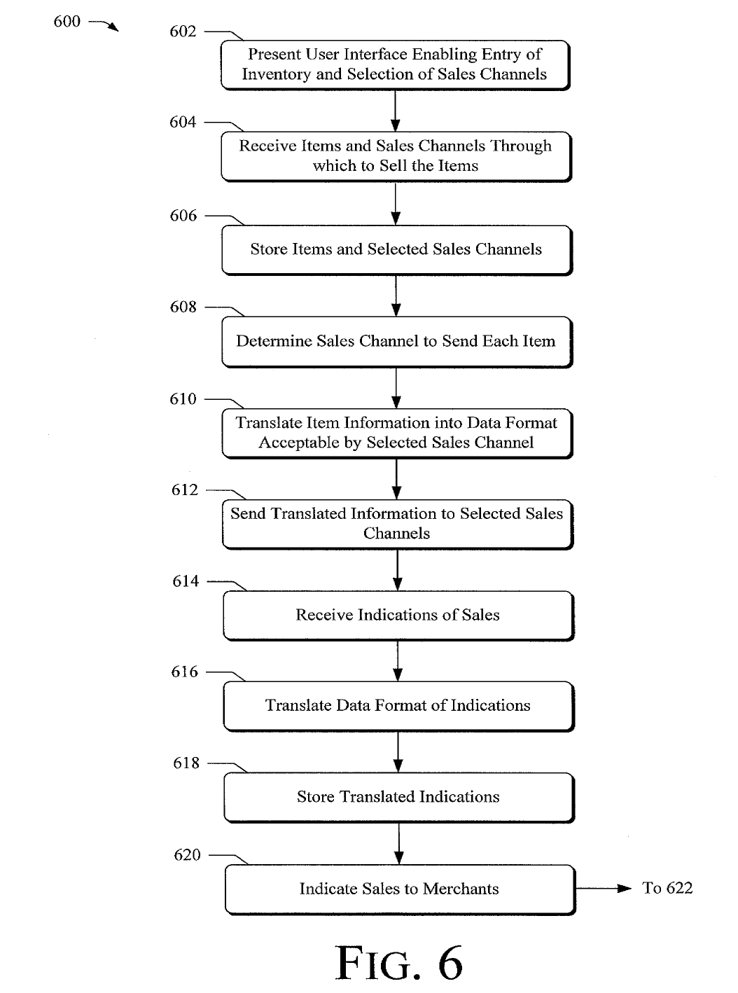

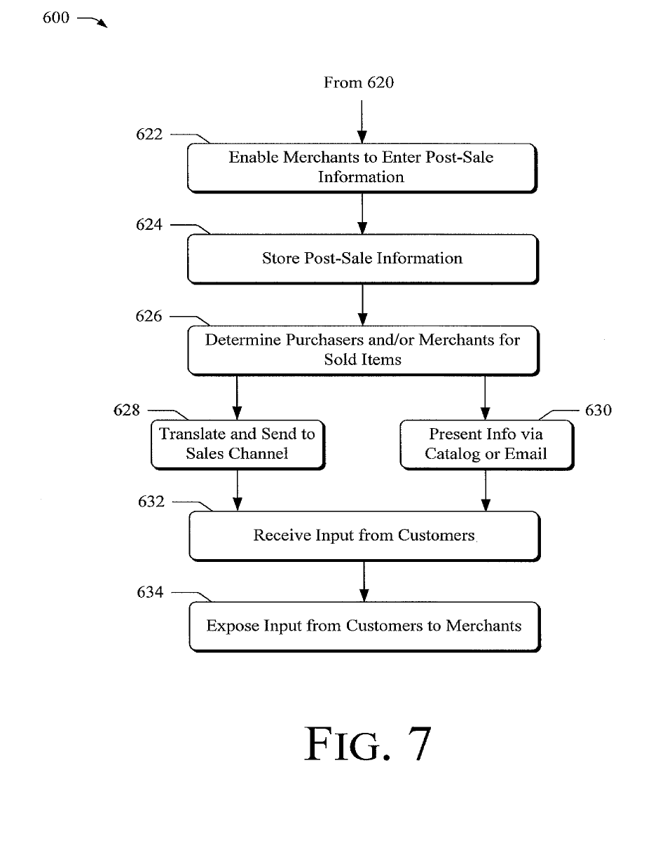

This discussion focuses on an exemplary process 600, which is set forth in FIGS. 6 and 7. This process and the exemplary actions related to FIGS. 2, 4, and 5 may be implemented in any suitable hardware, software, firmware, or combination thereof; in the case of software and firmware, this process and actions represent sets of operations implemented as computer-executable instructions stored in computer-readable media and executable by one or more processors. These embodiments of the tools are not intended to limit the scope of the tools or the claims. Process 600 is illustrated as series of blocks representing individual operations or acts performed by elements of operating environment 100 of FIG. 1, such as intermediary application 110.

Block 602 presents a user interface enabling entry of items and selection of sales channels through which the items may be offered for sale. Merchants may manually enter their inventory and select which items are to be sold and through whom, such as was described in the example illustrated in FIGS. 2 through 5. Merchants may also upload their inventory to the intermediary using another application, such as inventory application 116a or 116b.

The tools permit but do not require that merchants interact with a single user interface for all of their inventory, including items offered through network-enabled sales channels (e.g., Ebay™ and Amazon™), each merchant's physical store, or even items not for sale. This permits merchants to learn and use only one user interface to manage their inventory.

The single user interface may organize information for items into information generic to most sales channels and information specific to a small set of sales channels. Generic information is common to most sales channels, such as item name, number, description, type, and picture. Specific information may be unique to a particular sales channel or class of channels (e.g., fixed-price channels), though the intermediary may enable entry of specific information in a manner consistent with the overall look and feel of the user interface.

Block 604 receives entry of items and selection of sales channels through which to sell the items. As shown in FIG. 3 in the illustrated embodiment described above, the tools may receive from a merchant many items and selection of many different sales channels. When the merchant is using the intermediary as the merchant's only or unified inventory, the merchant may include items not offered for sale or offered only through its physical store.

The tools (at block 602) may aid merchants in entering information for items, such as specific information for items selected for sale by a particular sales channel. As noted above, the tools may auto-populate fields based on the merchant's history of interaction with that sales channel or default settings, such opening and closing an auction at particular times.

Block 606 stores the items and their sales channels, such as in catalog 128 of FIG. 1. The tools store information about the items and, when appropriate, when they sold, through whom, and to whom. This compilation of information about items, merchants, sales channels, and later in the process, customers, may be useful to any of these persons or entities. If a merchant wants to know which of its customers is within driving distance of its physical store, for example, the merchant may have this information available in the catalog. With this information the merchant will know to which of its customers to send invitations to events at its physical store. In some embodiments, customers can track all of their purchases made through any of the sales channels and from any merchant, even facts about items purchased long ago (such as their model number or warranty information). In some embodiments, merchants can use the intermediary to determine sales leads, based, for example, on historical purchases by a customer. In some embodiments, the intermediary can be used to determine the best sales channel through which to offer a particular product for sale based, at least in part, on historical sales of similar or related products through the various channels.

Block 608 determines through which sales channels each of the items are to be offered for sale, if any. In the illustrated example, for instance, the intermediary determined that items 310b and 310c were selected for sale through Ebay™ and that 310e was not for sale through any of the available sales channels.

Block 610 translates information about the items into a data format acceptable to each item's selected sales channel. The tools have available translation data about the accepted data formats of each of the sales channels and required information for each of the sales channels. A sales channel's accepted data format may be identical to the one used by that sales channel's own user interface intended for merchants. For Ebay™ for instance, the tools may translate the following information for an item in the intermediary's data format to the data format used by Ebay™:

Note also that the intermediary is extensible for any sales channel that exposes its accepted data format(s) or that has a data format that may be determined. Thus, while the illustrated embodiment shows large, commercial sales channels of: Ebay™, Amazon™, and pricescan.com™, others may also be used, such as CNET.com™, MSN.com™, Froogle.com™, and Live.com™.

Block 612 sends translated information for each item to its selected sales channel. Responsive to block 612 the sales channels offer their items for sale.

Block 614 receives one or more indications that items have sold. The sales channels may indicate sales for their respective items in their own accepted data format or in a data format accepted by the tools without translation. In the above illustrated embodiment, for instance, the sales channels send indications of sales and related information in their own interface's data format.

The indications may include a little or a lot of information about the sale, such as the item's number, a sale date, price, customer, and shipping address, or all of these and the customer's purchase history at the sales channel, fees owed to the sales channel incident to the sale, the customer's credit card or bank account number, and a preferred shipping method picked by the customer.

Block 616 translates indications for sales into the tool's data format, if needed. This translation is similar to reversing the translation made at block 610, though here other information is also translated.

Block 618 stores sales and/or indications for later use. The tools may update the catalog to indicate that an item has sold and all the other information associated with that sale. And the tools may expose some or all of this information to merchants or customers thereby enabling them to track their sales or purchases.

Block 620 indicates to merchants that the items sold and information related to the sales. This may be through an email to the merchant listing the item, that it sold, and associated information. It may also be through the updated catalog. The catalog's data may be exposed in the same layout and with the same user interface used when the merchant listed the item for sale. Using the same interface may make it easier for the merchant to view and understand as he or she will be familiar with that interface's layout.

Or the tools may download the information associated with the sales to each merchant's inventory or accounting applications, such as inventory or accounting application 116a or 118a of FIG. 1 for Merchant A. If downloading, the tools may need to translate the sale information into a data format acceptable to the merchant's application.

If downloading to an accounting application, the tools may update the merchant's accounts without interaction from the merchant, such as a price at which an item sold, expected shipping costs, and fees owed to the sales channel.

If downloading to an inventory application, the tools may update the merchant's own inventory without interaction from the merchant, such as which items sold and when. In either of these cases the tools may make it much easier for a merchant to sell through multiple sales channels (or even a single sales channel).

Block 622 enables merchants to enter post-sale information. If a merchant needs to ship the sold item (e.g., it isn't automatically shipped or downloaded), the merchant may want to indicate which carrier was used, the item's tracking number, when shipped, and an expected delivery date. The tools enable merchants to enter this information in a single layout through the intermediary's user interface.

Block 624 stores this information, such as in catalog 128 of FIG. 1.

Block 626 determines which items were purchased by which customer and/or from which merchant. The tools may select to inform a customer of all items bought by that customer, all items bought within a certain time period or from a certain merchant, or all items having associated post-sale information. The tools may want to inform Customer A from the illustrated embodiment above, for example, that all of his four items from four sales channels have been shipped and their tracking number or numbers. Or, if that customer also purchased items from another merchant, that those items have also been shipped, etc. The tools may proceed to blocks 628 and/or 630 depending on whether the tools make information about the items or sales available indirectly through the sales channel, shown at block 628, or directly to the purchaser at block 630.

Block 628 translates the post-sale information (if any) into a data format acceptable to the sales channel through which the item was sold and then sends information associated with that sale to the sales channel. Some sales channels are capable of providing post-sale information to customers, such as with an email having an item tracking number. In this way the tools enable the sales channel to expose this information to the customers.

Block 630 exposes information associated with purchased items directly to the customers. Block 630 may do so through an email with the information. It may also do so by exposing portions of the catalog through the intermediary's user interface or in some other manner. In any of these cases, the tools enable customers to view one or many purchased items from one or many merchants and through one or many sales channels. Customer A of the illustrated embodiment described with FIGS. 2-5, for instance, may view all four items purchased from four different sales channels through one user interface and that some or all have been shipped.

Block 632 receives input from customers. This may be from an email responding to the email sent by the tools at block 630 or through the user interface exposing portions of the catalog also at block 630. It may also be indirectly received from the sales channel in which case the input is translated into the data format used by the intermediary. This input may include an entry into a comments field or a change to an item purchased (e.g., from a blue caboose to a red caboose, if permitted by the merchant).

Block 634 exposes customer input to merchants. By so doing the tools provide potentially useful information to the merchants, such as that the customer wants to be on one merchant's mailing list, wants to change the item, or wants to purchase the same item bought through a large, commercial sales channel instead through a merchant's own website. As discussed earlier, some embodiments of the intermediary can process customer information and/or historical sales to develop sales leads for the merchant. For example, if the merchant wants to sell a red caboose, the intermediary could determine that Jim Smith has purchased a blue caboose in the past and may be interested in purchasing a red caboose. The intermediary could contact Jim Smith via email, instant message, RSS feed, cellular short message service (SMS) or other suitable means, to let Jim know that the merchant has a product in which Jim might be interested and identifying the sales channel through which the product can be purchased. Alternatively, the intermediary could provide the merchant with an indication of Jim's possible interest in the red caboose and the merchant could contact Jim directly.

### CONCLUSION

The above-described tools enable merchants to more easily sell items and customers to more easily track purchases made through multiple sales channels. In some embodiments, for example, the tools use a single user interface through which merchants may sell and maintain their inventory and customers track all of their purchases. Although the tools have been described in language specific to structural features and/or methodological acts, it is to be understood that the tools defined in the appended claims are not necessarily limited to the specific features or acts described. Rather, the specific features and acts are disclosed as exemplary forms of implementing the tools.

1. One or more computer-readable media having computer-readable instructions therein that, when executed by a computing device, cause the computing device to perform acts comprising:
presenting a user interface enabling entry of items and selection of different sales channels through which each of the items are to be offered for sale; and
responsive to receiving entry of items and selection of a different sales channel for each of the items, sending information about each of the items to its selected, different sales channel effective to enable the selected, different sales channels to offer the items for sale.

2. The media of claim 1, wherein the act of sending sends information about each of the items to its selected, different sales channel in a data format acceptable to its selected, different sales channel.

3. The media of claim 2, her comprising:
receiving, from each of the selected, different sales channels and in the data format acceptable to each of the selected, different sales channels, indications that the items offered for sale have sold; and
responsive to the act of receiving, indicating that the items have sold through the user interface.

4. The media of claim 3, further comprising translating, for each of the items, the information about each of the items from a first data format of the user interface into the data format acceptable to each item's selected, different sales channel and translating the indications from the data format acceptable to the selected, different sales channel to the first data format of the user interface.

5. The media of claim 1, further comprising storing the information about each of the items and wherein the information comprises which of the items have sold and to which sales channel each of the items is or was offered for sale.

6. The media of claim 5, wherein two of the items were sold to a purchaser through two of the selected, different sales channels and further comprising exposing the information associated with said two items to the purchaser through the user interface or a single other user interface.

7. The media of claim 1, further comprising receiving, from one of the selected, different sales channels, an indication that the item offered for sale through that selected, different sales channel has sold and indicating through the user interface that said item has sold and to a merchant from which entry of said item was received.

8. The media of claim 7, further comprising:
receiving through the user interface and after the act of indicating that said item has sold, post-sale item information for said item; and
sending the post-sale item information to that selected, different sales channel effective to enable the selected, different sales channel to present the post-sale item information to the customer that purchased said item.

9. The media of claim 7, further comprising:
receiving through the user interface and after the act of indicating that said item has sold, post-sale item information for said item; and
exposing the post-sale item information to the customer that purchased said item.

10. The media of claim 7, wherein the indication comprises accounting information and further comprising automatically providing the accounting information to an accounting application associated with the merchant.

11. The media of claim 7, further comprising automatically updating an inventory application associated with the merchant to indicate that said item has sold.

12. A method implemented at least in part by a computing device comprising:
receiving from different sales channels and in different data formats indications that items offered for sale through those different sales channels have sold;
determining that two or more of the items sold through the different sales channels were purchased by a particular customer; and
presenting information about said two or more items to the particular customer and through a single user interface.

13. The method of claim 12, wherein said two or more items were purchased from a single merchant selling through the different sales channels and further comprising enabling the particular customer to interact with the single merchant regarding said two more items through the single user interface.

14. The method of claim 12, wherein said two or more items were purchased from multiple merchants and further comprising enabling the particular customer to interact with the merchants and the different sales channels through the single user interface.

15. One or more computer-readable media having computer-readable instructions therein that, when executed by a computing device, cause the computing device to perform acts comprising:
enabling a merchant to offer items for sale through more than one sales channel where each of those sales channels have their own data format for items and without requiring that the merchant conform to those data formats; and
enabling presentation of the items in a single user interface to a customer that purchased the items through said more than one sales channel.

16. The media of claim 15, wherein the act of enabling the merchant to offer items for sale comprises:
receiving a selection for each of the items indicating to which sales channel each of the items is to be offered for sale;
receiving information about each of the items; and
translating the information for each of the items from a data format not used by the sales channel to which each of the items is to be offered for sale into that sales channel's own data format.

17. The media of claim 15, wherein the sales channels comprise an auction sales channel, a price comparison sales channel, a physical point of sale, or a search engine.

18. The media of claim 15, wherein the act of enabling the merchant is through a single user interface accepting entry of generic information for properties common to all of the sales channels and specific information for properties common to fewer than all of the sales channels.

19. The media of claim 15, further comprising enabling the customer to interact with said more than one sales channel through the single user interface.

20. The media of claim 15, further comprising enabling additional merchants to offer additional items for sale through said one or more sales channels and enabling presentation of the additional items to additional customers that purchased the additional items through said more than one sales channel.
